(19) United States
(12) Patent Application Publication
(10) Pub. No.: US 2003/0015107 A1
(43) Pub. Date: Jan. 23, 2003

(54) Imprinter apparatus

(75) Inventors: Shoichi Furukawa, Hiroshima-ken (JP); Hidetoshi Ohzeki, Hiroshima-ken (JP); Yoshiyuki Yamanoue, Hiroshima-ken (JP)

Correspondence Address: ARMSTRONG,WESTERMAN & HATTORI, LLP, 1725 K STREET, NW., SUITE 1000, WASHINGTON, DC, 20006, US

(73) Assignee: Mitsubishi Heavy Industries, Ltd., Tokyo (JP)

(21) Appl. No.: 10/179,173

(22) Filed: Jun. 26, 2002

(30) Foreign Application Priority Data
Jul. 17, 2001 (JP) 2001-217012
Feb. 14, 2002 (JP) 2002-036770

(51) Int. Cl. B41F 13/24

(52) U.S. Cl. 101/143; 101/182; 101/375

(57) ABSTRACT

The present invention relates to an imprinter unit, and is for the purpose of facilitating the plate replacement to reduce the work load. In an imprinter apparatus capable of replacing a portion of or all of a common pattern to be printed in a printer with a different pattern, there is provided a plate cylinder on which a press plate is mounted and a blanket cylinder to which a pattern on the press plate is transferred. The press plate is a gapless press plate having no joint.

### BACKGROUND OF THE INVENTION

(1) Field of the Invention

The present invention relates to an imprinter apparatus capable of replacing patterns (images) to be printed.

(2) Description of the Related Art

FIG. 10 is a side elevational view illustratively showing a construction of an essential part of an offset printing press put commonly to use. In the illustration, reference numeral 1 designates an arbitrary print unit of the duplicator, and if the duplicator is of the multi-color printing type, a plurality of print units 1 are located along a traveling path of a web 2.

In addition, reference numeral 101 denotes an imprinter unit, and in this illustration, it is placed on the upstream side of the print unit 1.

First of all, a description will be given hereinbelow of the print unit 1. The print unit 1 is composed of plate cylinders (print cylinders) 3 and blanket cylinders (transfer cylinders) 4. In this case, the print unit 1 has a printable construction on both surfaces of the web 2, and the plate cylinders 3a, 3b and the blanket cylinders 4a, 4b are located above and below the web 2, respectively. In the following description, if there is no need to distinguish particularly between the upper and lower sides, the plate cylinders and the blanket cylinders will be designated at numerals 3, 4, respectively.

Furthermore, as FIG. 11 shows, to each of the plate cylinders 3, there is attached a press plate 5 on which a pattern to be printed is formed by baking, and when an ink is supplied from an ink supply device (not shown) to the plate cylinder 3, the pattern on the press plate 5 is once transferred onto the blanket cylinder 4 and the pattern transferred thereonto is then printed on the web 2 which is in a traveling condition.

Still furthermore, after the completion of the printing of the pattern by the press plate 5, the press plate (old plate) 5 is removed therefrom, and a new press plate (new plate) having another pattern formed (by baking) is attached to the plate cylinder 3. A brief description here will be given of the replacement or exchange operation for the press plate 5. At the replacement of the press plate 5, a clamping device (not shown), mounted in a gap 6 defined in the plate cylinder 3, is made loose so that the other end side 5b of the press plate 5 is removed from the gap 6. Subsequently, the press plate 5 is detached while the plate cylinder 3 is rotated clockwise in FIG. 11. Finally, the press plate 5 is released from the plate cylinder 3 in a manner that one end side 5a of the press plate 5 is separated from one end portion of the gap 6. Moreover, the mounting operation of the press plate 5 is conducted in the reverse of the above-mentioned procedure.

In addition, a description will be given hereinbelow of the imprinter unit 101. This imprinter unit 101 is for replacing only a portion of a pattern to be printed in units of a predetermined number of copies, and although the common pattern constituting most of a printed surface is made to be printed by the print unit 1, a pattern different partially is made to be printed by the imprinter unit 101.

Concretely, this imprinter unit 101 is put to use when a description is added to some illustration with different languages. In this case, the illustration (common pattern) is printed by the print unit 1 while an explanatory sentence is printed by the imprinter unit 101 .

The imprinter unit 101 shown therein is of a type having a function to performing the printing on only a surface (upper surface) of the web 2, and is equipped with a first plate cylinder 103a, a first blanket cylinder 104a, a second plate cylinder 103b, a second blanket cylinder 104b, an impression cylinder 105, guide rollers 106 to 109, and other components.

A concrete description will be given hereinbelow of a case of printing a store name.

Press plates (not shown), having different patterns (in the above example, different-language explanatory sentences) form thereon by baking, are mounted over the first and second plate cylinders 103a and 103b, respectively. As illustrated, the first plate cylinder 103a and the first blanket cylinder 104a are brought into a “released condition” with respect to the web 2 while the second plate cylinder 103b and the second blanket cylinder 104b are brought into a “contacted condition” therewith so that the explanatory sentence of the language (first language) formed on the press plate of the second plate cylinder 103b by baking is printed on a predetermined place of the web 2.

In addition, after the completion of the printing of the first language, the second plate cylinder 103b and the second blanket cylinder 104b are set in the “released condition” while, at the same time, the first plate cylinder 103a and the first blanket cylinder 104a are set in the “contacted condition”, thus switching into the printing of the explanatory sentence of the second language.

In this connection, in the above-mentioned imprinter unit 101, during the printing by one plate cylinder and one blanket cylinder, the press plate (old plate) is removed from the other plate cylinder and a new press plate (new plate) is set thereon in preparation for the next printing. In this case, as well as those used in the print unit 1, the press plate is mounted in a state wound around the plate cylinder 103, and the detachment and attachment of the press plate are made as in the case of the procedure for the press plate 5 in the print unit 1.

Incidentally, although the above description has been done on the example in which the object (printed information) to be printed in the imprint unit 101 is a language(s), naturally the information to be printed in the imprinter unit 101 is not limited to this. The imprinter unit 101 comes into widespread use, for example, when a portion of the information to be printed in the print unit 1 is altered every predetermined number of copies.

Moreover, the above-mentioned imprinter unit 101 is designed to have a function to print on only one surface of the web 2, and for the printing on both the surfaces of the web 2, the printing will be made with, for example, two imprinters 101 each corresponding to the above-mentioned unit 101.

Still moreover, if the replacement of a pattern for a portion of the printed surface is unnecessary, that is, if the imprint unit 101 is put in a non-used condition, the web 2 is set in a state indicated by the broken line in FIG. 10.

Meanwhile, since this imprinter unit 101 is applied to small-lot printing, such as the printing based on the replacement of a portion of the printed surface mentioned above, there arises a problem in that the replacement frequency of the press plate becomes high to cause a large burden on work to be imposed on the operator. In addition, there exists a request for making easier the press plate replacement work itself to the utmost.

Still additionally, when an operator performs the replacement of a press plate, the operator works near a web put into a traveling condition and, therefore, a request for the improvement of the safety exists.

### SUMMARY OF THE INVENTION

The present invention has been developed in consideration of these objects and problems, and it is therefore an object of the invention to provide an imprinter apparatus capable of lessening the work burden by facilitating the plate replacement and of improving the safety.

For this purpose, in accordance with the present invention, an imprinter apparatus having a pattern-replaceable function to put a different pattern in place of a portion of or all of a pattern to be printed by a printer, comprises a plate cylinder holding a press plate and a blanket cylinder to which a pattern on the press plate is transferred, with the press plate including a seamless press plate providing a gapless structure.

This construction enables easy replacement of the press plate and reduction of the burden to be imposed on an operator.

Preferably, the press plate is attachable/detachable to/from the plate cylinder by being shifted along an axial direction of the plate cylinder.

This not only enables the burden on the operator to be considerably reduced at the plate replacement but also improves the safety of the plate replacement operations.

In addition, preferably, the gapless press plate is constructed as a pattern-replaceable regenerative gapless press plate, and a regenerative local plate maker for rewriting the pattern on the press plate is located in the vicinity of the plate cylinder and the press plate is made to be attachable/detachable to/from the plate cylinder and to/from the regenerative local plate maker by being shifted in an axial direction of the plate cylinder.

This construction enables the repeated use of the press plate and considerable reduction of the cost involved in the plate replacement. Moreover, the attachment/detachment to/from the plate cylinder and the attachment/detachment to/from the local plate maker can simultaneously be made through one operation in which the press plate is shifted along the axial direction of the plate cylinder, which enhances the working efficiency considerably.

Still additionally, preferably, the gapless press plate is constructed as a pattern-replaceable regenerative gapless press plate, and a regenerative local plate maker is provided which rewrites the pattern on the press plate.

This also enables the repeated use of the press plate and considerable reduction of the cost involved in the plate replacement.

Moreover, preferable, the regenerative local plate maker is made so that a pattern on a press plate to be used next for printing is rewritable during an operation of the printer. This enables quick replacement even at the subsequent plate replacement operations.

Still moreover, preferably, the gapless press plate is made with a seamless sleeve elasticity deformable in its radial direction. This enables the press plate to be fixedly secured to the plate cylinder by a frictional force, thus eliminating the need for the means for fixing the press plate on the plate cylinder. Yet moreover, it is preferable to include a lipophobic layer formed on the sleeve for defining a non-image area and a lipophilic layer formed on the lipophobic layer for defining an image area. This enables easy regeneration of the press plate and easy writing thereon.

In addition, preferably, a driving source for the plate cylinder and the blanket cylinder is placed independently of a driving source for the printer. In this case, it is possible to achieve the print replacement by controlling the rotational speed of each of the driving sources without changing the traveling speed of a web, that is, without changing the print speed.

### BRIEF DESCRIPTION OF THE DRAWINGS

FIG. 1 is an illustrative view showing a construction of an essential part of an imprinter apparatus according to an embodiment of the present invention;

FIGS. 2(a) and 2(b) are illustrative side elevational views useful for explaining an operation of the imprinter apparatus according to the embodiment of the present invention;

FIG. 3 is a perspective view illustratively showing a gapless press plate applied to the imprinter apparatus according to the embodiment of the present invention;

FIG. 4 is a cross-sectional view illustratively showing the gapless press plate applied to the imprinter apparatus according to the embodiment of the present invention;

FIG. 5 is an illustrative view useful for explaining the attachment/detachment of the gapless press plate applied to the imprinter apparatus according to the embodiment of the present invention, to/from a plate cylinder;

FIGS. 6(a) and 6(b) are illustrative views showing a first modification of the imprinter apparatus according to the embodiment of the present invention;

FIGS. 7(a) and 7(b) are illustrative views showing a second modification of the imprinter apparatus according to the embodiment of the present invention;

FIGS. 8(a) and 8(b) are illustrative views showing a third modification of the imprinter apparatus according to the embodiment of the present invention;

FIGS. 9(a) and 9(b) are illustrative views showing a fourth modification of the imprinter apparatus according to the embodiment of the present invention;

FIG. 10 is a side elevational view illustratively showing a construction of a general offset printing press; and

FIG. 11 is an illustrative view showing a plate cylinder and press plate to be used for the general offset printing press.

### DESCRIPTION OF THE PREFERRED EMBODIMENTS

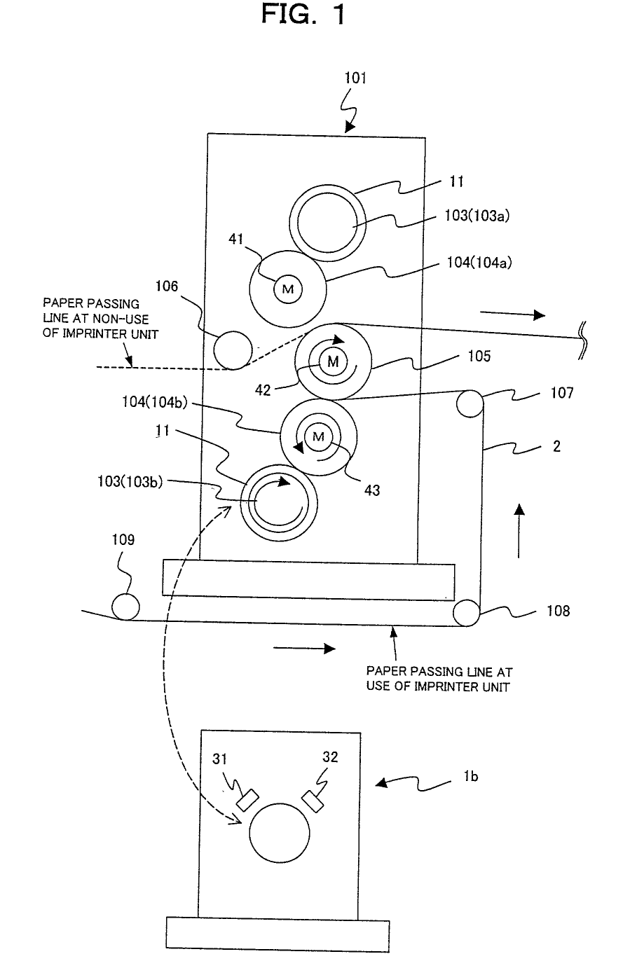

Referring now to the drawings, a description will be given hereinbelow of an imprinter apparatus according to an embodiment of the present invention. FIG. 1 is a side elevational view illustratively showing a construction of an essential part thereof.

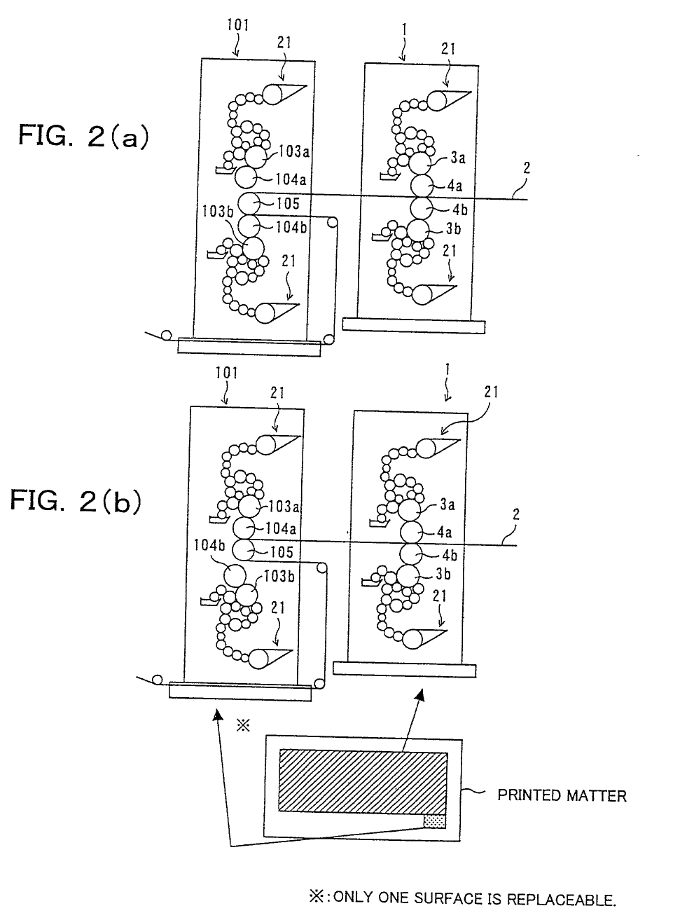

In FIG. 1, reference numeral 101 designates an imprinter unit for an offset printing press and numeral 2 denotes a web. On the downstream side of this imprinter unit 101, a print unit (printer) 1 is placed as shown in FIGS. 2(a) and 2(b). The print unit 1 is constructed similarly to that in the related art mentioned above, and the detailed description thereof will be omitted for brevity.

The imprinter unit 101 includes a first plate cylinder 103a, a first blanket cylinder 104a, a second plate cylinder 103b, a second blanket cylinder 104b, an impression cylinder 105, guide rollers 106 to 109, and other components. In the following description, when there is no need to particularly distinguish between these components, the plate cylinders and the blanket cylinders will simply be designated at reference numerals 103 and 104, respectively.

In addition, to each of the plate cylinder 103 of the imprinter unit 101, there is attached a press plate 11 on which a pattern (image) to be printed is formed by baking, and inks are supplied from an ink supply device 21 shown in FIGS. 2(a) and 2(b) to the plate cylinder 103. The pattern on the press plate 11 is once transferred onto the blanket cylinder 104 and the pattern transferred thereonto is then printed on the web 2 which is in a traveling condition.

Still additionally, as FIG. 1 shows, the imprinter unit 101 is additionally equipped with a regenerative local plate maker (which will hereinafter be referred to simply as a local plate maker) 1b. The local plate maker 1b is for once erasing (regenerating) a pattern on the press plate 11 which was already used for printing and for putting a new pattern thereon by baking. In this case, it is placed at a side area (local side) of the imprinter unit 101. Moreover, as illustrated, the local plate maker 1b is composed of a plate regenerating unit 31 for the regeneration of a pattern and a plate writing unit 32 for the writing of a pattern.

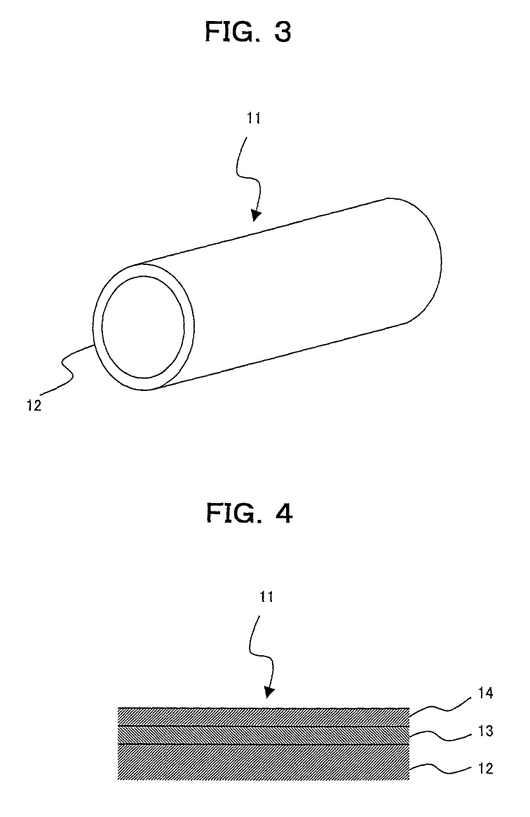

Meanwhile, as FIG. 3 shows, the press plate 11 is constructed as a seamless press plate providing a gapless structure. The employment of this gapless press plate 11 eliminates the useless portions, which are not available for the printing, on the circumferential surface of the press plate 11.

This gapless press plate 11 is constructed with a seamless (gapless) sleeve 12, and a coat layer (lipophobic layer or hydrophilic layer) and an organic compound layer (lipophilic layer or hydrophobic layer) are formed on the sleeve 12 as will be mentioned later.

In addition, similarly, a gapless (seamless) rubber plate (not shown) having no joint is mounted over the blanket cylinder 104, and is constructed as a so-called gapless blanket cylinder. Incidentally, the gapless blanket cylinder is well known, and the description thereof will be omitted for simplicity.

The sleeve 12 is made of an elastically deformable material, such as a nickel material, and has a cylindrical configuration with both open ends. The inner diameter of this sleeve 12 is made to be slightly smaller than the outer diameter of the plate cylinder 103 being the mounted object so that the press plate 11 is fixedly secured onto the plate cylinder 103 by the frictional force with the plate cylinder 103 when mounted over it.

Still additionally, as FIG. 4 shows, a coat layer (lipophobic layer) 13 made of titanium oxide (TiO₂) is formed on the sleeve 12. This coat layer 13 is formed by depositing titanium oxide on the nickel sleeve 12, and functions as a section (non-image area) to which inks are not attached.

In this case, the titanium oxide coat layer 13 contains a titanium oxide photocatalyst as a photocatalyst, and for example, the coat layer 13 shows a high lipophobic property (hydrophilic property) owing to the effects of the titanium oxide photocatalyst when ultraviolet rays are applied thereto. The portions exposed to the ultraviolet rays or the like are formed as a non-image area free from the attachment of inks.

Incidentally, although the above-mentioned example relates to the employment of the titanium oxide (TiO₂) for the coat layer 13, it is also appropriate to use aluminum (Al) in place of the titanium oxide. Moreover, as a way of forming the coat layer 13, the present invention is not limited to the above-mentioned deposition, but various methods are also acceptable.

Furthermore, an organic compound layer (lipophilic layer) 14 is formed on the coat layer 13. This organic compound layer 14 is made of an organic compound, thus providing no attachment of water but attachment of inks.

A description will be given hereinbelow of one example of a method of forming the organic compound layer 14. This organic compound layer 14 is formed by dissolving an organic compound, acting as a lipophilic agent (hydrophobic agent) when sticking fixedly to or react on the surface of the coat layer 13, in water or the solution of an organic solvent and further by applying the resultant liquid onto the surface of the coat layer 13 and drying it.

A pattern is written on the organic compound layer 14 by means of the aforesaid plate writing unit 32 (see FIG. 1). The plate writing unit 32 is equipped with a write head (not shown) made to emit an infrared laser beam, and when the infrared laser beam is applied to the organic compound layer 14, the portion exposed to the laser beam is heated and cured to be fixedly secured onto the coat layer 13.

Following this, the portion which was not exposed to the laser beam is cleaned and removed so that the non-image area of the coat layer 13 appears, thus forming a pattern comprising an image area(s) and a non-image area(s) on the press plate 11.

Accordingly, over the entire surface of the press plate accommodated in the local plate maker 1b at the plate replacement or exchange, an organic compound (lipophilic layer) 14 is evenly formed, by the regenerating unit 31 above mentioned thereby erasing all the pattern on the press plate 11. Subsequently, the infrared laser beam is applied thereto from the plate writing unit 32 as mentioned above to form a new pattern. In this way, the press plate 11 is designed as a regenerative gapless press plate on which the pattern is repeatedly rewritable.

Meanwhile, in this local plate maker 1b, the writing on the press plate 11 to be used for the next printing is made during the operation of the imprinter unit 101. After the completion of the writing of a new pattern, this press plate 11 is placed at a predetermined position to make ready for the next plate replacement.

In addition, at the plate replacement, the press plate (old plate) 11 is detached from the plate cylinder 103 and is accommodated in the local plate maker 1b, and at the same time, the press plate (new plate) 11 is attached onto the plate cylinder 103, thus shortening the work time for the plate replacement.

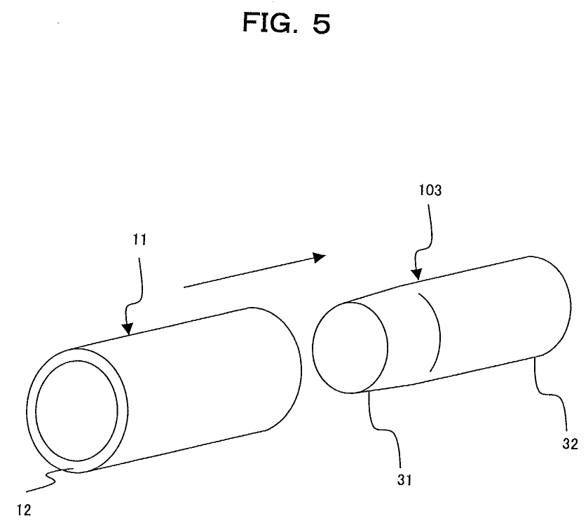

Furthermore, as FIG. 5 shows, at the plate replacement, the press plate 11 is pulled out from and fitted over the plate cylinder 103 in axial directions for the attachment/detachment thereof. This is one of big features of the press plate (gapless press plate) 11 formed into a cylindrical configuration, which contributes to the great improvement of the efficiency of the plate replacement.

In this case, the outer diameter of the plate cylinder 103 is made to be slightly larger than the inner diameter of the sleeve 12, and the press plate 11 is fixedly secured onto the plate cylinder 103 through the use of the elastic deformation of the sleeve 12. Moreover, as FIG. 5 shows, the plate cylinder 103 is made such that its one end side 31 is made to be smaller in diameter than the other end side 32 for forming a tapered configuration, which facilitates the attachment of the press plate 11 to the plate cylinder 103.

Still furthermore, the local plate maker 1b is located just beside the plate cylinder 103, and this location of the local plate maker 1b enables the detachment of the old press plate 11 from the plate cylinder 103 and the accommodation in the local plate maker 1b to be completed through one operation, that is, in a manner that the press plate (old plate) 11 is shifted in an axial direction with respect to the plate cylinder 103. Likewise, at the attachment of the press plate (new plate) 11, the press plate 11 held in the local plate maker 1b is shifted in an axial direction so that the detachment of the new plate 11 from the local plate maker 1b and the attachment thereof to the plate cylinder 103 is achieved through one operation.

Meanwhile, this imprinter unit 101 has a driving source independent of that for the print unit (reference numeral 1 in FIG. 2) (sectional drive). Concretely, provided are a first motor 41 for driving the first plate cylinder 103a and the first blanket cylinder 104a, a second motor 42 for driving the impression cylinder 105 and a third motor 43 for driving the second plate cylinder 103 band the second blanket cylinder 104b. Each of these motors 41 to 43 is controlled in rotational speed in accordance with a control signal from a controller (not shown).

Since the imprinter apparatus according to the embodiment of the present invention has been constructed as described above, for example, as FIGS. 2(a) and 2(b) show, a pattern of a common portion of a printed matter is printed by the print unit 1, while a partial pattern for the replacement is printed by the imprinter unit 101 every predetermined number of copies.

In this case, for example, in the state shown in FIG. 2(a), a partial pattern positioned on a right and lower side of the printed surface is printed by the second plate cylinder 103b and the second blanket cylinder 104b. After the completion of the printing up to a predetermined number of copies, the switching is made as shown in FIG. 2(b) without stopping the traveling of the web 2 so that the printing is made by the first plate cylinder 103a and the first blanket cylinder 104a to accomplish the partial replacement of the pattern to be printed.

At this time, the second plate cylinder 103b and the second blanket cylinder 104b are changed from the “contacted condition” (see FIG. 2(a)) to the “released condition” (see FIG. 2(b)), while the first plate cylinder 103 and the first blanket cylinder 104a standing by in the “released condition” shown in FIG. 2(a) is changed to the “contacted condition” (see FIG. 2(b)).

In addition, thereafter, the rotation of the motor 43 is stopped to cease the second plate cylinder 103b and the press plate (old plate) 11, which has already been used for the printing, is shifted in its axial direction to be removed from the plate cylinder 103b and, at the same time, accommodated in the local plate maker 1b.

The movement of the press plate 11 in the axial direction of the plate cylinder 103b allows simultaneously the removal of the press plate 11 from the plate cylinder 103b and the accommodation thereof in the local plate maker 1b.

Still additionally, in the local plate maker 1b, the pattern on the old plate 11 is erased by the regenerating unit 31 and a new pattern is then written by the writing unit 32. That is, in the imprinter unit 101, the preparation for the next printing is made while the printing is made.

After the completion of the writing of the new pattern, the press plate 11 is axially shifted this time toward the plate cylinder 103b, thereby accomplishing the detachment of the press plate 11 from the local plate maker 1b and the attachment thereof to the plate cylinder 103b simultaneously.

Moreover, when the printing by the first plate cylinder 103a approaches the completion, the motor 43 is rotationally driven to increase the rotational speeds of the second plate cylinder 103b and the second blanket cylinder 104b to be equal to the traveling speed of the print unit 1, and simultaneous with the completion of the printing by the first plate cylinder 103a, the first plate cylinder 103a and the first blanket cylinder 104a are set to the “released condition” while the second plate cylinder 103b and the second blanket cylinder 104b are switched into the “contacted condition”. Thus, the replacement with the new printing by the second plate cylinder 103b can be made without stopping the traveling of the web 2. The above-mentioned operations are repeatedly done after this.

As described above, in the imprinter apparatus according to the present invention, the press plate 11 is made with a gapless press plate having no joint, and therefore, the press plate 11 is easily replaceable. In particular, since the press plate 11 is attachable/detachable with respect to the plate cylinder 103 by being shifted along axial directions of the plate cylinder 103, the burden imposed on an operator is considerably reducible at the plate replacement. Moreover, since it is possible to eliminate the need for the operator to get near the traveling line of the web 2 for the plate replacement, the safety at the operation improves significantly.

In addition, since the press plate 11 is constructed as a regenerative gapless press plate which permits the rewriting of patterns and the regenerative local plate maker 1b is placed in the vicinity of the plate cylinder 103, the repeated use of the press plate 11 becomes possible and the cost for the plate replacement is sharply reducible. Still additionally, since the attachment/detachment to/from the plate cylinder 103 and the attachment/detachment to/from the local plate maker 1b can be achieved through one operation in which the press plate 11 is shifted along the axial directions of the plate cylinder 103, the working efficiency is significantly improvable.

Moreover, in the local plate maker 1b, since the rewriting of a pattern on the press plate 11 to be used for the next printing is made during the operation of the imprinter unit 101, quick replacement operations become feasible even at the following plate replacements.

Still moreover, since the gapless press plate 11 is constructed with a radially elastically deformable seamless sleeve 12, the press plate 11 can be fixedly secured onto the plate cylinder 103 by means of a frictional force. This can eliminate the need for the means to fix the press plate 11 to the plate cylinder 103.

Furthermore, the formation of the coat layer (lipophobic layer) 13 on the sleeve 12 for defining a non-image area and the formation of the organic compound layer (lipophilic layer) 14 on the coat layer 13 for defining an image area facilitate the regeneration of the press plate 11 and the rewriting thereon.

Still furthermore, since the imprinter unit 101 has driving sources (motors) 41 to 43 provided independently of the driving sources of the print unit 1, the print replacement can be made by controlling the rotational speeds of the motors without changing the traveling speed of the web 2 (that is, without changing the printing speed in the print unit 1).

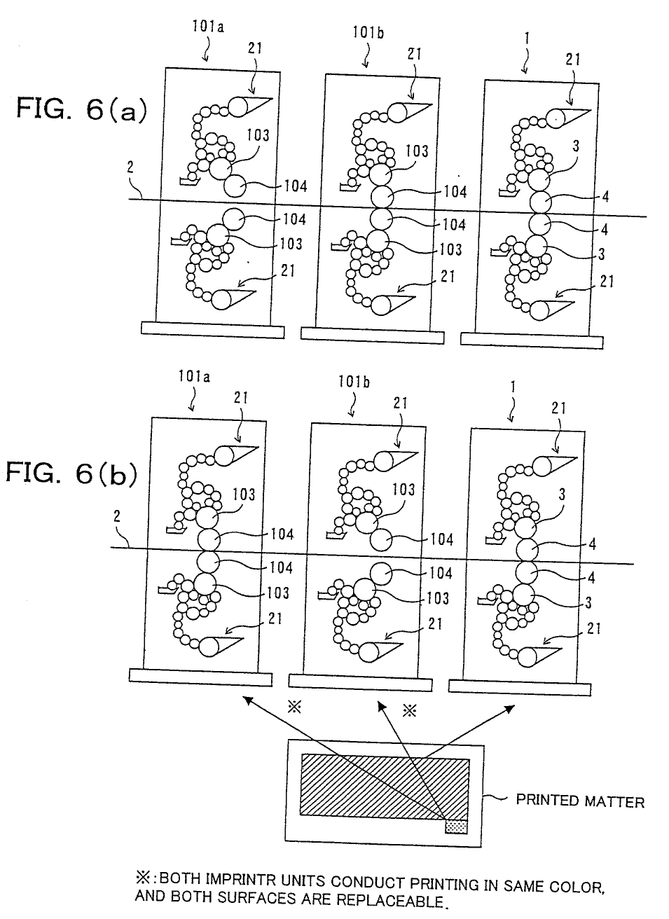

Secondly, a description will be given hereinbelow of a first modification of the imprinter apparatus according to the embodiment of the invention. FIGS. 6(a) and 6(b) are illustrations of a construction of an essential part thereof. In this modification, imprinter units 101a and 101b are designed to be capable of printing on both surfaces, i.e., front and rear surfaces, of a web 2, but the other constructions are similar to those in the above-described embodiment. The two imprinter units 101a and 101b are alternately driven in replacing print information on a portion of a printed surface.

In addition, as illustrated, a print unit 1 is located on the downstream side of these imprinter units 101a and 101b. This print unit 1 is similar to those in the above-described embodiment and in the above-described conventional technique, and the detailed description thereof will be omitted for simplicity.

Still additionally, each of the imprinter units 101a and 101b is constructed similarly to the print unit 1, and is equipped with plate cylinders 103 and blanket cylinders 104 at upper and lower sides, thus accomplishing the printing on both the surfaces of the web 2.

Although not shown here, a regenerative local plate maker (see numeral 1b in FIG. 1), as described above in the embodiment, is located beside each of the imprinter units 101a and 101b.

Moreover, in this modification, as FIG. 6(b) shows, the imprinter units 101a and 101b are designed to be capable of printing at the same place of a printed matter, any one of the imprinter units 101a and 101b is selectively driven for print replacement.

In the imprinter units 101a and 101b, the other constructions are made similarly to that in the above-described embodiment.

Accordingly, for the printing on the web 2, as FIG. 6(a) shows, the upper and lower blanket cylinders 104, 104 of one imprinter unit 101a are set to the “released condition” with respect to the web 2, while the other (right side in the illustration) imprinter unit 101b is set to the “contacted condition”.

Thus, different information are printed at a right and lower side of a printed surface and a left and lower side of the rear surface by the other imprinter unit 101b every predetermined number of copies, while the entire pattern is printed by the print unit 1 lying on the downstream side.

Furthermore, for the print replacement of a portion of the printed surface, as FIG. 6(b) shows, the upper and lower blanket cylinders 104, 104 of the one (left side in the illustration) imprinter unit 101a are set to the “contacted condition” with respect to the web 2, while the other (right side in the illustration) imprinter unit 101b is set to the “released condition”, which allows the print replacement.

Still furthermore, at such print replacement, the replacement (or exchange) and rewriting of the press plate (not shown) of the imprinter unit which is in the “released condition” are conducted by means of the above-mentioned regenerative local plate maker. Incidentally, the press plate replacement and rewriting operations are the same as those in the above-described embodiment, and the description thereof will be omitted for brevity.

As described above, in the first modification, in addition to the above-mentioned advantages and effects of the embodiment, an advantage exists that the print replacement on both surfaces are simultaneously achievable.

Although, in the above description, the regenerative local plate maker is located beside each of the imprinter units 101a and 101b, it is also appropriate that, as another construction, a common (that is, one) regenerative local plate maker is located for the imprinter units 101a and 101b. In this case, the cost reduction and space-saving becomes feasible.

Furthermore, a description will be given hereinbelow of a second modification thereof. This second modification is for enabling multi-color printing (process color printing) through the use of the imprinter units 101 described above in the first modification.

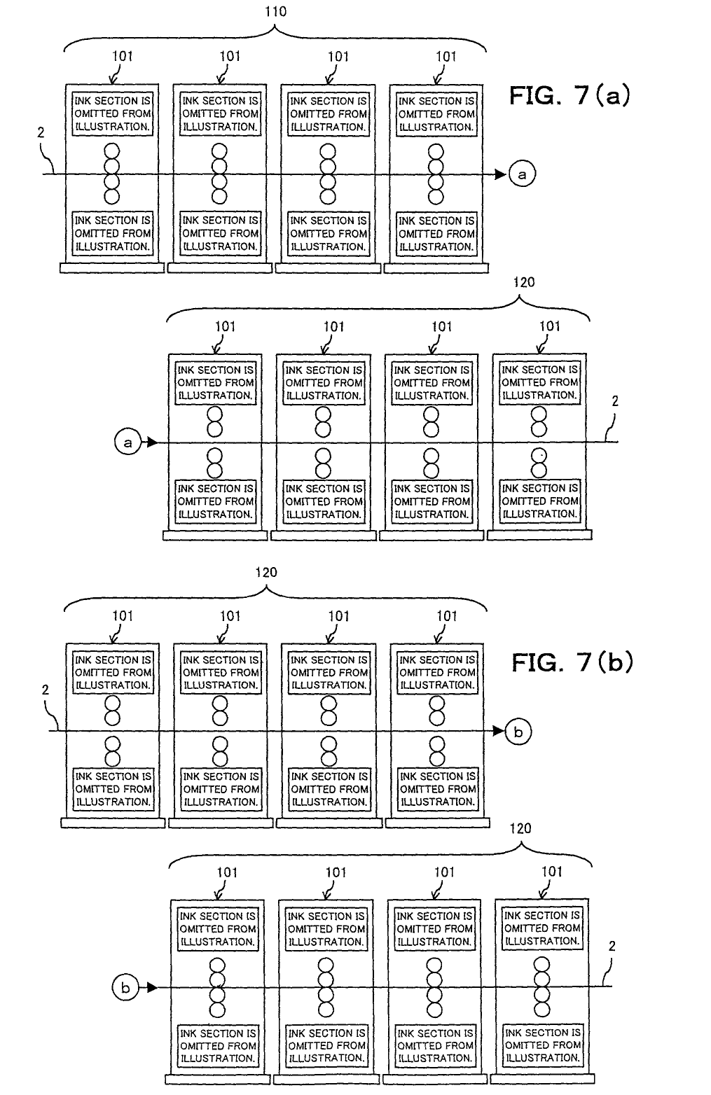

In this second modification, as FIGS. 7(a) and 7(b) show, eight imprinter units 101 are located along a path for the traveling of a web 2. These imprinter units 101 are divided into a first imprinter unit group 110 comprising four imprinter units 101 lying on the upstream side and a second imprinter unit group 120 comprising four imprinter units 101 lying on the downstream side, with different patterns being replaceable by the first imprinter unit group 110 and the second imprinter unit group 120.

In addition, in each of the first and second imprinter unit groups 110 and 120, black, red, blue and yellow inks are given to the imprinter units 101, respectively, arranged in descending order of location, i.e., from the upstream side to the downstream side. Accordingly, the process color printing becomes possible in the first imprinter unit group 110 and the second imprinter unit group 120.

Still additionally, although not illustrated, also in this second modification, a regenerative local plate maker (see numeral 1b in FIG. 1), mentioned above in the embodiment, is placed at the side of each of the imprinter units 101 so that the press plate of each of the imprinter units 101 becomes rewritable.

With this construction, for the process color printing on the web 2, as FIG. 7(a) shows, each of the imprinter units 101 of the first imprinter unit group 110 is set to the “contacted condition” with respect to the web 2, while each of the imprinter units 101 of the second imprinter unit group 120 is set to the “released condition”.

Thus, the process color printing is made by the first imprinter unit group 110 and the entire pattern is printed by the printing unit (not shown) lying on the downstream side.

Furthermore, for the replacement of a portion of print information, as FIG. 7(b) shows, each of the imprinter units 101 of the first imprinter unit group 110 is set to the “released condition” while each of the imprinter units of the second imprinter unit group 120 is set to the “contacted condition”, thus conducting the color print replacement by the imprinter units 101.

Still furthermore, at such print replacement, the replacement and rewriting of the press plate (not shown) of each of the imprinter units 101 which is in the “released condition” are made through the use of the above-mentioned regenerative local plate maker.

As described above, in this second modification, in addition to the advantages and effects of the embodiment described above, an advantage exists that the replacement of the entire print can be done simultaneously on both surfaces the process color printing can be made by the imprinter units 101.

Although, in the above description, the regenerative local plate maker is located beside each of the eight imprinter units 101, it is also appropriate that, as another construction, a common (that is, one) regenerative local plate maker is located for a plurality of imprinter units 101. In this case, one local plate maker can be provided for the eight imprinter units 101, or one local plate maker can also be provided for each of the imprinter unit groups 110 and 120. In addition to these configurations, naturally, the number of local plate makers to be provided is properly changeable.

Furthermore, a description will be given herein below of a third modification thereof. This third modification is for enabling the replacement of the entire pattern of one color in the process color printing, rather than the above-described first modification which is designed to replace a portion of a pattern.

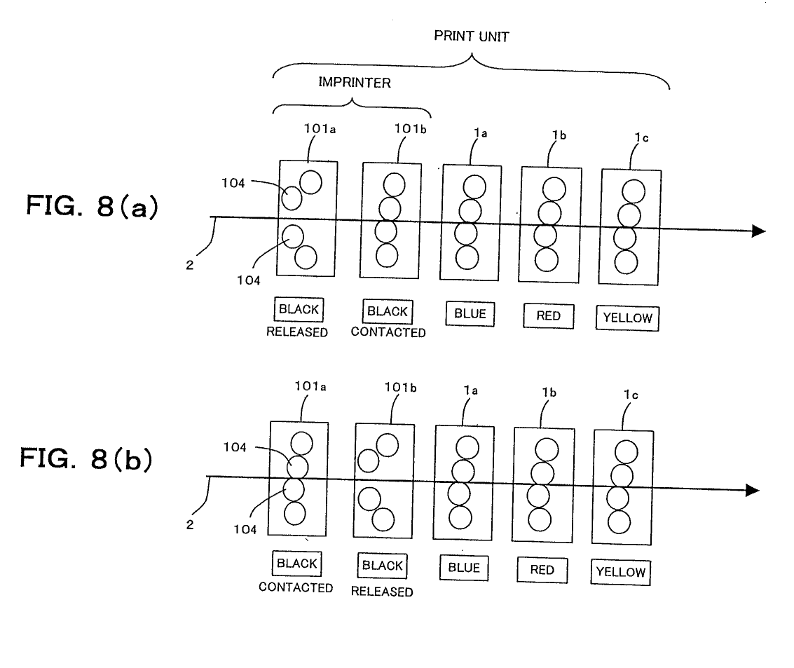

That is, as FIGS. 8(a) and 8(b) show, in this third modification, two imprinter units 101a and 101b and three print units 1a to 1c are provided in the order from the upstream side to the downstream side. Of these, the imprinter units 101a and 101b is for conducting the black-color printing, and are made to be capable of printing on both surfaces of a web 2. Moreover, the print units 1a to 1c are made to perform the blue, red and yellow printing, respectively, and are also made to be capable of printing on both the surfaces of the web 2.

In addition, patterns with different contents are written in the imprinter units 101a and 101b, respectively. In this case, unlike the above-described embodiment or first modification handling a portion of a pattern, in these imprinter units 101a and 101b, a pattern is written in the entire area (for example, an oblique line area of a printed matter in FIG. 2). This is constructed similarly to that of the first modification.

Accordingly, the alternate operations of the two imprinter units 101a and 101b allows the replacement of the entire pattern to be printed in black color.

That is, for conducting the printing on the web 2, as FIG. 8(a) shows, the upper and lower blanket cylinders 104 and 104 of one imprinter unit 101a are set to the “released condition” with respect to the web 2, while the other imprinter unit 101b is set to the “contacted condition”.

In this way, black portions of the entire patterns on the front and rear surfaces of a printed surface are printed by the other imprinter unit 101b, and the blue, red and yellow portions of the patterns are printed by the print units 1a to 1c lying on the downstream side.

Furthermore, for the print replacement of the black portions, as FIG. 8(b) shows, the upper and lower blanket cylinders 104 and 104 of the one imprinter unit 101a are set to the “contacted condition” with respect to the web 2 while the other imprinter unit 101b is set to the “released condition”. This enables the print replacement of the black portions.

At such print replacement, as in the case of the above-described embodiment, the replacement and rewriting of the press plate (not shown) of the imprinter unit which is in the “released condition” are conducted by means of the above-mentioned regenerative local plate maker.

Accordingly, in this third modification, in addition to the advantages and effects of the above-described embodiment, it is possible to perform the print replacement on the entire pattern.

In addition, a description will be given hereinbelow of a fourth modification thereof. This fourth modification is designed so that the above-described third modification is applied to each of color print units.

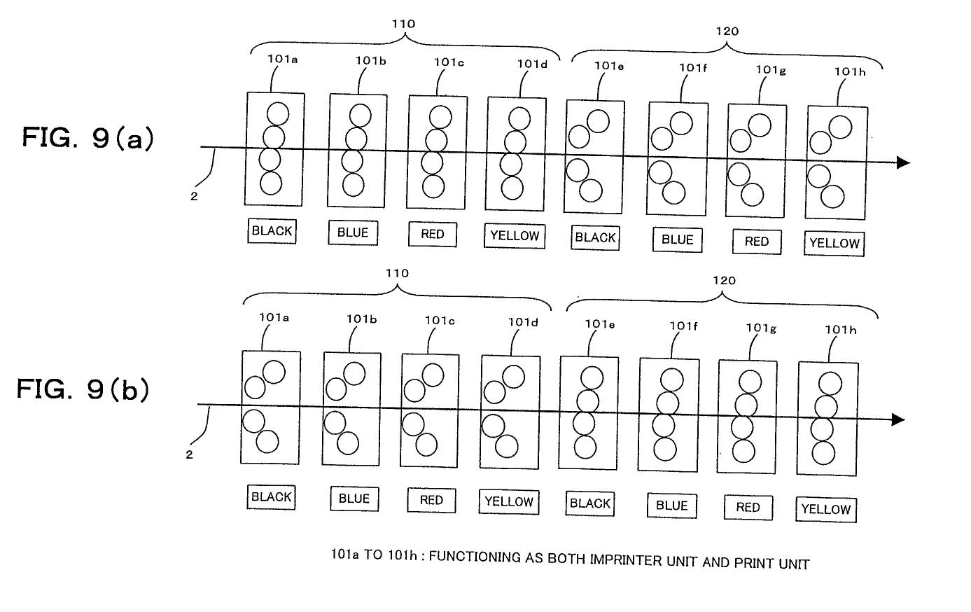

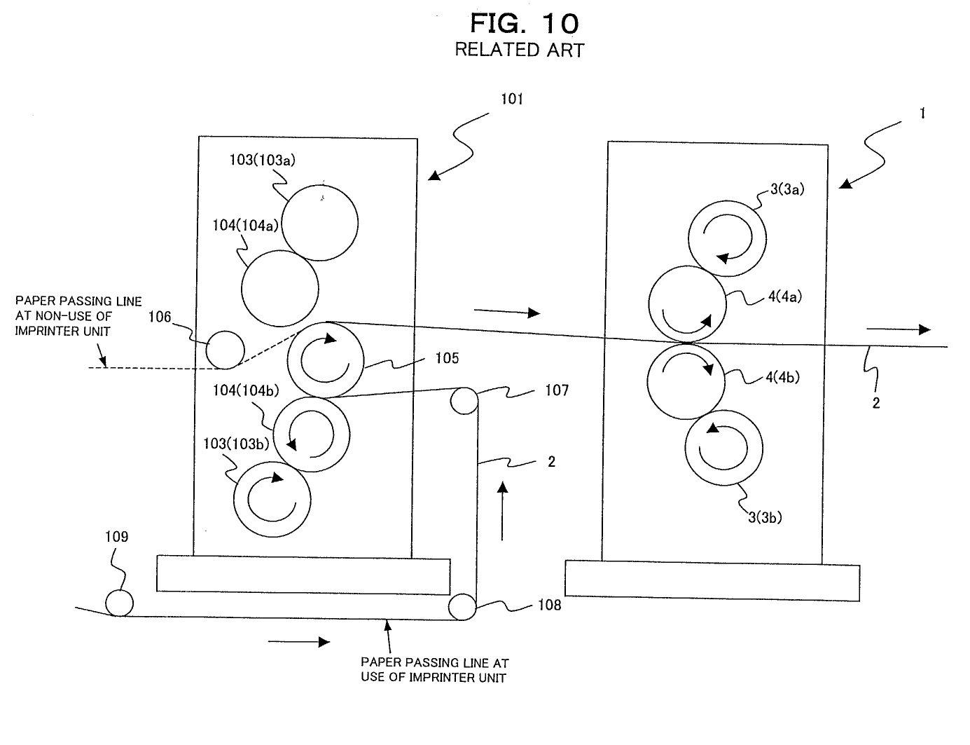

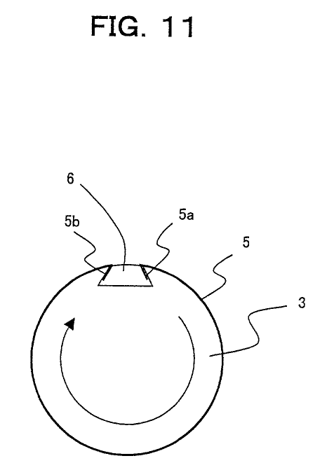

That is, in this fourth modification, as FIGS. 9(a) and 9(b) shows, eight imprinter units 101a to 101h are provided along the traveling path of a web 2. Of these, four upstream-side imprinter units 101a to 101d constitutes a first imprinter unit group 110, while four downstream-side imprinter units 101e to 101h organize a second imprinter unit group 120.

In addition, black, blue, red and yellow colors are given to the imprinter units of each of these imprinter unit groups 110 and 120, respectively, arranged in descending order of location from the upstream side, so that the process color printing can be made by the first imprinter unit group 110 and the second imprinter unit group 120.

Still additionally, instead of a portion of a pattern, a pattern is written over the entire area on a press plate (not shown) of each of the imprinter units 101a to 101h. Yet additionally, in this fourth modification, the alternate operations of these two imprinter unit groups 110 and 120 enables the replacement on all colors in the entire pattern to be printed.

Incidentally, in this case, the entire pattern is printed by the imprinter units 101a to 101h, and for this reason, these imprinter units 101a to 101h also function as a print unit.

Moreover, although not illustrated, also in this fourth modification, a regenerative local plate maker (see numeral 1b in FIG. 1), described above in the embodiment, is placed beside each of the imprinter units 101a to 101h, thus enabling the rewriting of the press plate of each of the imprinter units 101a to 101h.

Also in the above description of the fourth modification, although the regenerative local plate maker is located beside each of the eight imprinter units 101a to 101h, it is also appropriate that, as another construction, a common (that is, one) regenerative local plate maker is located for a plurality of imprinter units 101. In this case, one local plate maker can be provided for the eight imprinter units 101, or one local plate maker can also be provided for each of the imprinter unit groups 110 and 120. In addition to these configurations, naturally, the number of local plate makers to be provided is properly changeable.

Accordingly, for the process color printing on the web 2, as FIG. 9(a) shows, the imprinter units 101a to 101d of the first imprinter unit group 110 are set to the “contacted condition” with respect to the web 2 while the imprinter units 101e to 101h of the second imprinter unit group 120 are set to the “released condition”.

In this way, the process color printing is made by the first imprinter unit group 110. On the other hand, for the print replacement, as FIG. 9(b) shows, the imprinter units 101a to 101d of the first imprinter unit group 110 are set to the “released condition” while the imprinter units 101e to 101h of the second imprinter unit group 120 are set to the “contacted condition”, thus conducting the replacement of the process color printing wholly through the use of the imprinter units 101.

In addition, at such print replacement, the replacement and rewriting of the press plate (not shown) of the imprinter unit 101 which is in the “released condition” are made by the above-mentioned regenerative local plate maker.

Accordingly, in this fourth modification, in addition to the advantages and effects of the above-described embodiment, an advantage exists that the replacement of the entire print can be done simultaneously on both surfaces.

It should be understood that the present invention is not limited to the above-described embodiments, and that it is intended to cover all changes and modifications of the embodiments of the invention herein which do not constitute departures from the spirit and scope of the invention. For example, it is also appropriate that the one-side printing imprinter units 101 in the above-described embodiment are provided to be four in number for enabling the process color printing.

In addition, in the above-described embodiment and modifications, it is also possible that a regenerative on-machine plate maker is used in place of the regenerative local plate maker. The regenerative on-machine plate maker is a plate maker which is integrally built in an imprinter unit 101, and it is located around the plate cylinder 103 of the imprinter unit 101.

In the case of the mounting of such a regenerative on-machine plate maker, since a new pattern can be formed on the press plate by baking without removing the press place from the plate cylinder 103, that is, in a state where the press plate remains attached to the plate cylinder 103, it is possible to eliminate the need for the press plate replacement except that due to the life (regeneration limit) of the press. Moreover, even at the plate replacement due to the regeneration limit of the press plate, since the press plate is of the gapless type, the plate replacement becomes easy to shorten the working time significantly.

In addition, it is also possible to employ an intermediate construction between the third modification and the fourth modification. That is, although only one color is wholly replaceable in the third modification and the four colors are all replaceable over the entire print area in the fourth modification, it is possible to design the apparatus so that two or three colors are replaceable over the entire print area.

What is claimed is:

1. An imprinter apparatus having a pattern-replaceable function to put a different pattern in place of a portion of or all of a pattern to be printed by a printer, comprising:
a plate cylinder holding a press plate; and
a blanket cylinder to which a pattern on said press plate is transferred,
wherein said press plate is constructed as a gapless press plate having no joint.

2. An imprinter apparatus according to claim 1, characterised in that said press plate is attachable/detachable to/from said plate cylinder in a manner that said press plate is shifted along an axial direction of said plate cylinder.

3. An imprinter apparatus according to claim 2, characterised in that said gapless press plate is constructed as a pattern-replaceable regenerative gapless press plate, and a regenerative local plate maker for rewriting said pattern on said press plate is located in the vicinity of said plate cylinder, and further said press plate is made to be attachable/detachable to/from said plate cylinder and to/from said regenerative local plate maker in a manner that said press plate is shifted in an axial direction of said plate cylinder.

4. An imprinter apparatus according to claim 3, characterised in that said regenerative local plate maker is made so that a pattern on a press plate to be used next for printing is rewritable during an operation of said printer.

5. An imprinter apparatus according to claim 4, characterised in that said gapless press plate includes:
a seamless sleeve elastically deformable in its radial direction;
a lipophobic layer formed on said sleeve for defining a non-image area; and
a lipophilic layer formed on said lipophobic layer for defining an image area.

6. An imprinter apparatus according to claim 5, characterised in that a driving source for said plate cylinder and said blanket cylinder is placed independently of a driving source for said printer.

7. An imprinter apparatus according to claim 4, characterised in that a driving source for said plate cylinder and said blanket cylinder is placed independently of a driving source for said printer.

8. An imprinter apparatus according to claim 3, characterised in that said gapless press plate includes:
a seamless sleeve elastically deformable in its radial direction;
a lipophobic layer formed on said sleeve for defining a non-image area; and
a lipophilic layer formed on said lipophobic layer for defining an image area.

9. An imprinter apparatus according to claim 8, characterised in that a driving source for said plate cylinder and said blanket cylinder is placed independently of a driving source for said printer.

10. An imprinter apparatus according to claim 3, characterised in that a driving source for said plate cylinder and said blanket cylinder is placed independently of a driving source for said printer.

11. An imprinter apparatus according to claim 2, characterised in that said gapless press plate is constructed as a pattern-replaceable regenerative gapless press plate, and a regenerative local plate maker is provided which rewrites said pattern on said press plate.

12. An imprinter apparatus according to claim 11, characterised in that said regenerative local plate maker is made so that a pattern on a press plate to be used next for printing is rewritable during an operation of said printer.

13. An imprinter apparatus according to claim 12, characterised in that said gapless press plate includes:
a seamless sleeve elastically deformable in its radial direction;
a lipophobic layer formed on said sleeve for defining a non-image area; and
a lipophilic layer formed on said lipophobic layer for defining an image area.

14. An imprinter apparatus according to claim 13, characterised in that a driving source for said plate cylinder and said blanket cylinder is placed independently of a driving source for said printer.

15. An imprinter apparatus according to claim 12, characterised in that a driving source for said plate cylinder and said blanket cylinder is placed independently of a driving source for said printer.

16. An imprinter apparatus according to claim 11, characterised in that said gapless press plate includes:
a seamless sleeve elastically deformable in its radial direction;
a lipophobic layer formed on said sleeve for defining a non-image area; and
a lipophilic layer formed on said lipophobic layer for defining an image area.

17. An imprinter apparatus according to claim 16, characterised in that a driving source for said plate cylinder and said blanket cylinder is placed independently of a driving source for said printer.

18. An imprinter apparatus according to claim 11, characterised in that a driving source for said plate cylinder and said blanket cylinder is placed independently of a driving source for said printer.

19. An imprinter apparatus according to claim 2, characterised in that said gapless press plate includes:
a seamless sleeve elastically deformable in its radial direction;
a lipophobic layer formed on said sleeve for defining a non-image area; and
a lipophilic layer formed on said lipophobic layer for defining an image area.

20. An imprinter apparatus according to claim 19, characterised in that a driving source for said plate cylinder and said blanket cylinder is placed independently of a driving source for said printer.

21. An imprinter apparatus according to claim 2, characterised in that a driving source for said plate cylinder and said blanket cylinder is placed independently of a driving source for said printer.

22. An imprinter apparatus according to claim 1, characterised in that said gapless press plate is constructed as a pattern-replaceable regenerative gapless press plate, and a regenerative local plate maker for rewriting said pattern on said press plate is located in the vicinity of said plate cylinder, and further said press plate is made to be attachable/detachable to/from said plate cylinder and to/from said regenerative local plate maker in a manner that said press plate is shifted in an axial direction of said plate cylinder.

23. An imprinter apparatus according to claim 22, characterised in that said regenerative local plate maker is made so that a pattern on a press plate to be used next for printing is rewritable during an operation of said printer.

24. An imprinter apparatus according to claim 23, characterised in that said gapless press plate includes:
a seamless sleeve elastically deformable in its radial direction;
a lipophobic layer formed on said sleeve for defining a non-image area; and
a lipophilic layer formed on said lipophobic layer for defining an image area.

25. An imprinter apparatus according to claims 24, characterised in that a driving source for said plate cylinder and said blanket cylinder is placed independently of a driving source for said printer.

26. An imprinter apparatus according to claim 23, characterised in that a driving source for said plate cylinder and said blanket cylinder is placed independently of a driving source for said printer.

27. An imprinter apparatus according to claim 22, characterised in that said gapless press plate includes:
a seamless sleeve elastically deformable in its radial direction;
a lipophobic layer formed on said sleeve for defining a non-image area; and
a lipophilic layer formed on said lipophobic layer for defining an image area.

28. An imprinter apparatus according to claim 27, characterised in that a driving source for said plate cylinder and said blanket cylinder is placed independently of a driving source for said printer.

29. An imprinter apparatus according to claim 22, characterised in that a driving source for said plate cylinder and said blanket cylinder is placed independently of a driving source for said printer.

30. An imprinter apparatus according to claim 1, characterised in that said gapless press plate is constructed as a pattern-replaceable regenerative gapless press plate, and a regenerative local plate maker is provided which rewrites said pattern on said press plate.

31. An imprinter apparatus according to claim 30, characterised in that said regenerative local plate maker is made so that a pattern on a press plate to be used next for printing is rewritable during an operation of said printer.

32. An imprinter apparatus according to claim 31, characterised in that said gapless press plate includes:
a seamless sleeve elastically deformable in its radial direction;
a lipophobic layer formed on said sleeve for defining a non-image area; and
a lipophilic layer formed on said lipophobic layer for defining an image area.

33. An imprinter apparatus according to claim 32, characterised in that a driving source for said plate cylinder and said blanket cylinder is placed independently of a driving source for said printer.

34. An imprinter apparatus according to claim 31, characterised in that a driving source for said plate cylinder and said blanket cylinder is placed independently of a driving source for said printer.

35. An imprinter apparatus according to claim 30, characterised in that said gapless press plate includes:
a seamless sleeve elastically deformable in its radial direction;
a lipophobic layer formed on said sleeve for defining a non-image area; and
a lipophilic layer formed on said lipophobic layer for defining an image area.

36. An imprinter apparatus according to claim 35, characterised in that a driving source for said plate cylinder and said blanket cylinder is placed independently of a driving source for said printer.

37. An imprinter apparatus according to claim 30, characterised in that a driving source for said plate cylinder and said blanket cylinder is placed independently of a driving source for said printer.

38. An imprinter apparatus according to claim 1, characterised in that said gapless press plate includes:
a seamless sleeve elastically deformable in its radial direction;
a lipophobic layer formed on said sleeve for defining a non-image area; and
a lipophilic layer formed on said lipophobic layer for defining an image area.

39. An imprinter apparatus according to claim 38, characterised in that a driving source for said plate cylinder and said blanket cylinder is placed independently of a driving source for said printer.

40. An imprinter apparatus according to claim 1, characterised in that a driving source for said plate cylinder and said blanket cylinder is placed independently of a driving source for said printer.
